(19) United States
(12) Patent Application Publication
(10) Pub. No.: US 2022/0065553 A1
(43) Pub. Date: Mar. 3, 2022

(54) METHOD FOR PERFORMING CYCLICAL ENERGY STORAGE AND DEVICE THEREFOR

(71) Applicant: IVOC-X GMBH, Jena (DE)

(72) Inventors: Thomas Krech, Erfurt (DE); Dennis Sippach, Jena (DE); Torsten Langer, Stadtroda (DE)

(21) Appl. No.: 17/297,376

(22) PCT Filed: Dec. 4, 2019
(86) PCT No.: PCT/EP2019/083678

§ 371 Date: May 26, 2021

(30) Foreign Application Priority Data
Dec. 7, 2018 (DE) 10 2018 131 256.3
Nov. 20, 2019 (DE) 10 2019 131 345.7

(51) Int. Cl. F28D 20/00; F28F 27/00; F28D 17/00

(52) U.S. Cl. CPC F28D 20/0056; F28D 2020/0082; F28D 17/005; F28F 27/006

(57) ABSTRACT

The invention relates to a method and to a device for performing cyclical energy storage for a process region in a cyclical operation using an energy storage medium having a hot side and a cold side, the method comprising the following method steps, which are repeated in a cycle time. The energy storage medium is heated on the hot side by means of a hot medium in order to initiate internal thermal conduction in the energy storage medium from the hot side to the cold side. The temperature on the cold side of the energy storage medium is continuously captured by means of a temperature sensor and is compared with a preset limit temperature. After the limit temperature has been reached, a cold medium is fed to the cold side of the energy storage medium and the stored energy is discharged beginning from the cold side toward the hot side of the energy storage medium. At the start of a new energy storage cycle, the energy storage medium is heated on the hot side again.

The invention relates to a method for performing cyclical energy storage having the features of claim 1 and a device therefor having the features of claim 14.

Methods for energy storage and corresponding devices for energy storage are used and required according to the state of the art wherever heat is generated and transferred or transferable to a (solid, liquid, gaseous, plasma) fluid, wherein this energy storage cannot be transferred efficiently due to technical reasons, accrues with a time delay, and therefore has to be stored temporarily.

Moreover, certain technical processes are performed cyclically, wherein, however, temperature-controlling the process region as constant as possible should be achieved which has to be performed either as heating, cooling or else both of heating and cooling. In such a case, the cyclically generated heat must be discharged from the process and be returned into the process flow in the correct timing cycle of the cyclical process. In the conventional state of the art, heat exchanger systems are in particular employed in the latter case, which are coupled to external heat or cold media. In such heat exchanger systems, heat accruing in the process is not recovered or stored but discharged to the outside or fed into the process from outside. Such processes thus inevitably need external heat sources and heat sinks.

According to the state of the art, such heat exchangers often are employed in the form of pipe bundles and plate arrangements or comparable structures which are preponderantly characterized by a large inner surface. The large inner surface is necessary for the optimum and efficient heat transfer and an effective thermal coupling of the process region to the environment. For this reason, these heat exchanger systems need to be dimensioned the larger, the higher the requirements as to their efficiency are set.

Due to the fluidic structure, such heat exchanger systems can be classified into various constructional forms. Common are cross-flow heat exchangers by means of which a heat recovery of up to 50% is possible, and countercurrent heat exchangers achieving a heat recovery degree of up to 80%. For the most effective heat recovery, it is advantageous to have the highest possible thermal conductivity of the heat exchanger materials, the tines possible transition layers, the largest possible heat exchanging surface, and the highest possible temperature differences between the thermally contacted areas. Such heat exchangers moreover necessitate a sufficiently large extent of thermal insulation so as to minimize undesired heat losses.

For the rapid heat transfer, large temperature differences are therefore necessary since the velocity of the heat flow within the material is thereby increased. In case of temperature differences being too low, the recovery degree of the energy drops correspondingly. The thinner the heat transferring layer and the larger the surface for the heat transfer within the heat exchanger, the lower the resistance for the heat transfer.

This means consequently that large heat recovery rates can only be realized by small plate distances within the heat exchanger and/or by enlarging the system length for increasing the surface within a defined constructional space. Moreover, a turbulent flow has shown to be necessary within conventional heat exchangers. This results in a pressure loss that is in part very high. Otherwise, laminar flow, however, cannot be used since so-called thermal bypasses develop in a laminar flow due to the insufficient heat exchange with the heat transferring surface. Generating the turbulent flow in turn requires disproportionally high energy expenditure and the use of additional, correspondingly dimensioned additional components that are technically complex and cost-intensive, such as, e.g., compressors, ventilators, pumps, and more similar devices for overcoming the differential pressure developing from turbulent flow. This means according to the state of the art that heat exchanger arrangements are not suitable for cyclical heat recovery of corresponding cyclic processes.

The heat storage possibility as such is very limited in heat exchangers according to the state of the art. This already results form the fact that heat exchangers need to be made of a material having very good thermal conductivity, and heat thus gets rapidly lost by discharge. Heat exchangers thus do not allow to be practically used as heat storing components in reality.

In addition, there is the lack of adaptability. Heat exchangers are planned as a completely dimensioned component and inserted in a given system. In the following, this component is not adaptable subsequently, and most of the time is difficult to maintain or to repair.

Known energy storage systems according to the state of the art, on the contrary, balance the necessary entire capacities on the basis of the entirely required energy or heat amount or the available space. These normally are not configured for dynamic and cyclic operation but are conceived for quasi statically performed heat storage which is not useful for cyclic processes.

Consequently, the task is to realize an energy storage system which is constructed more efficiently and compactly than the systems according to the state of the art, has less pressure loss and, moreover, has higher flexibility and reduced losses. The demanded method for energy storage and the corresponding device are intended to realize energy storage that can also be used for the shortest possible process time, and which in this case is able to smooth and homogenize the heat flow as efficiently as possible, so that the heat accruing in and to be supplied to the process region can be made available correspondingly quickly and with a minimum of delay in the process cycle.

The solution of the mentioned task is performed by means of a method for performing cyclical energy storage having the features of claim 1, and a device therefor having the features of claim 15. The dependent claims include appropriate and/or advantageous configurations and embodiments of the method and/or device.

The method according to the invention for performing cyclical heat storage/energy storage for a process space is performed in a cyclical operation using a storage medium. The storage medium is in contact with an area of higher temperature, referred to as hot side hereinafter, and with an area of lower temperature, referred to as cold side hereinafter. Either the hot side or the cold side constitutes the process region to be temperature-controlled. The method is performed within a cycle time, wherein the following method steps are repeated in the energy storage cycle as follows:

In a first step, the energy storage medium is heated on the hot side by means of a hot medium in order to initiate internal thermal conduction in the energy storage medium from the hot side to the cold side. Hereby, a heat front is developed proceeding from the hot side of the energy storage medium toward the cold side.

In association therewith, sensor values are continuously registered on the cold side of the energy storage medium by means of a sensor. The continuous temperature is compared with a preset limit temperature. Finally, the proceeding of the heat front in the energy storage medium is hereby monitored, and its arrival on the cold side is registered in a timely manner.

After the limit temperature has been reached, a cold medium is fed to the cold side of the energy storage medium, and the stored heat is discharged beginning from the cold side toward the hot side of the energy storage medium. Hereby, the heat stored in the energy storage medium is returned toward the hot side, and namely before the cold side of the energy storage medium exceeds the defined preset limit temperature. Hereby, passive energy losses on the cold side are avoided, on the one hand, a pre-definition of the cycle time of the energy storage is performed via the specification of the limit temperature on the other hand.

The limit temperature can be variably set to the process. If the stored energy is too high, excess energy may thereby be removed from the system. As alternatives, there are the separation processes of fluids and media mentioned further below.

The mentioned method steps now are repeated cyclically. Thus, a new heating of the energy storage medium is performed on the hot side, and thus a new energy storage cycle is started.

The basic idea of the method according to the invention consequently is energy storage a priori configured to be cyclical, in which the internal thermal conduction in the energy storage material is almost completely suppressed, and in which the internal thermal conduction, or to be more precise, the marginal conditions in the form of the limit temperature, defines a measure for the duration of the energy storage cycle. This results in a coordination of the energy storage with a process a priori configured to be cyclical, which is in particular performed dynamically.

In an appropriate configuration of the method, the cyclical operation of energy storage has two different phases. These are a starting phase and a working phase. In the starting phase, several energy storage cycles are passed through until the cycle time for each energy storage cycle has reached a constant limit cycle time. This will not change within the next energy storage cycles, provided the process acting from outside remains unchanged.

In the subsequent working phase, the energy storage cycles then are performed each within the limit cycle time. The starting phase thus marks a settling process of the cyclical energy storage which has adjusted to a dynamic equilibrium in the subsequent working phase. In the subsequent working phase, energy quantities can be withdrawn from or introduced into the energy storage in a relatively quick manner, wherein the limit temperature is reached quickly or drops below this value quickly. The energy quantities in the energy storage introduced or withdrawn during the working phase will then correspond to this temperature change.

In a further configuration of the method, the energy storage medium is formed as a material of bad thermal conduction and flow-through capability. The hot medium of flow-through capability flows through the material from the hot side toward the cold side, and the cold medium flows through the material from the cold side to the hot side.

In a further embodiment of the method, the energy storage medium is allocated to two energy storage modules that are fluidically separated from one another. Both energy modules are adjacent to a process space to be temperature-controlled, and a volume flow flows through the energy storage modules and the process space. On this occasion, both energy storage modules are operated in a cyclical push-pull manner. This allows a particularly smoothly proceeding temperature-control of the cyclical process to be realized.

According to the invention, a device for performing energy storage on a process space by means of an energy storage module has the following components: an energy storage body of a material of low thermal conductivity is provided, through which a fluidic medium can flow. Furthermore, an outer thermal insulation at least partially surrounding the heat storage body is provided, as well as at least one respective connection for introducing and/or discharging a fluid. Moreover, at least one temperature sensor arranged on the energy storage body in the medium flowing through it and measures the temperature of the fluid is provided.

In one embodiment, the energy storage body is composed of ceramics of low thermal conductivity that can be flown through. An implementation of several molded bodies in the form of monoliths, granulate or powder is also possible.

In a further embodiment, an arrangement of two heat storage modules adjacent to the process space and fluidically directly separated from one another is provided.

The arrangement of two energy storage modules can be configured in different ways. In a first embodiment, the energy storage modules are linearly connected on both sides to the process region.

In a further embodiment, the energy storage modules are connected to the process region in a U-shape.

In an exemplary embodiment, the energy storage bodies have a prismatic shape with an arbitrarily selectable base area. Of course, cylindrical and cuboid configurations are included herein as a possibility.

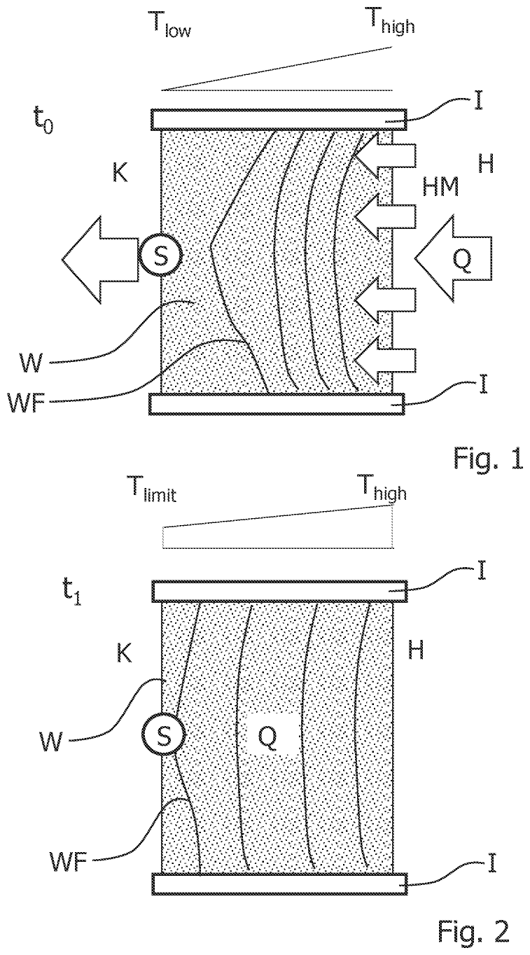

The method and the device will be explained in more detail below on the basis of exemplary embodiments. The attached FIGS. 1 to 12 serve for clarification. The same reference numerals are used for identical parts and/or parts of identical action.

Shown are in:

FIG. 1 the first method step in an exemplary execution,

FIG. 2 the second method step in an exemplary performance,

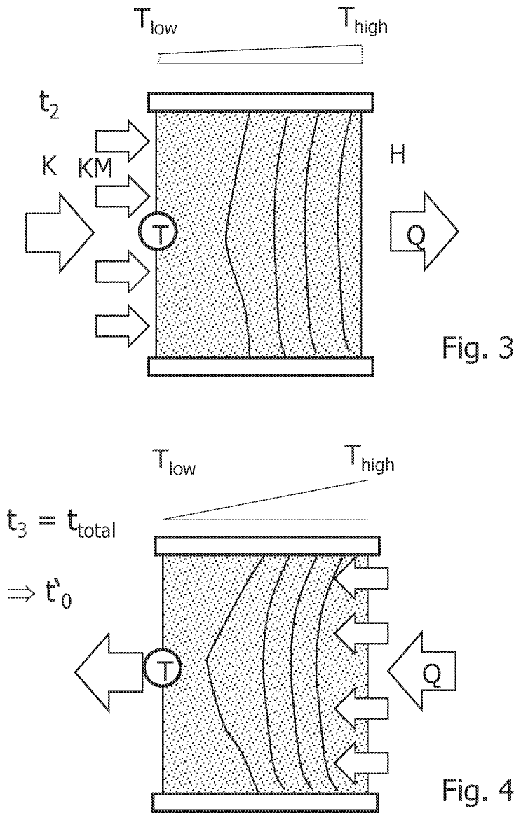

FIG. 3 the third method step in an exemplary performance,

FIG. 4 the renewed first method step following the third method step in an exemplary performance,

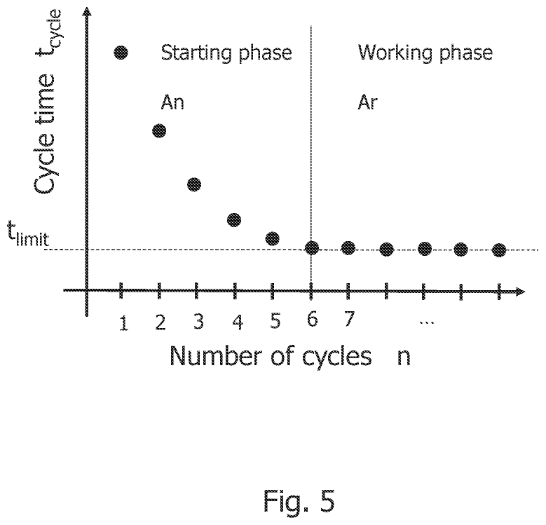

FIG. 5 a representation of the cycle time as a function of the number of cycles,

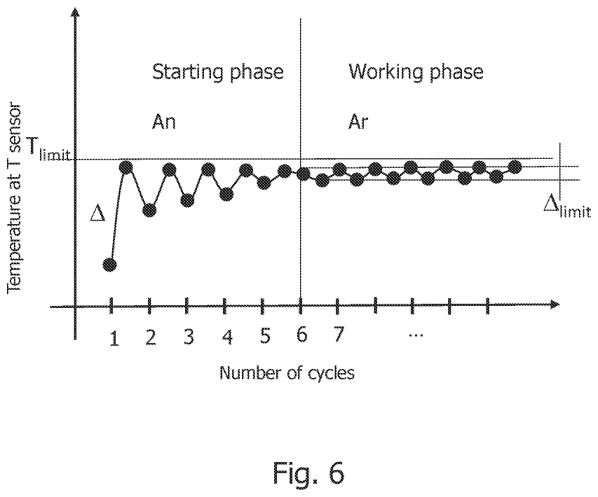

FIG. 6 a schematic representation of the temperature profile on the cold side of the energy storage body as a function of the number of cycles,

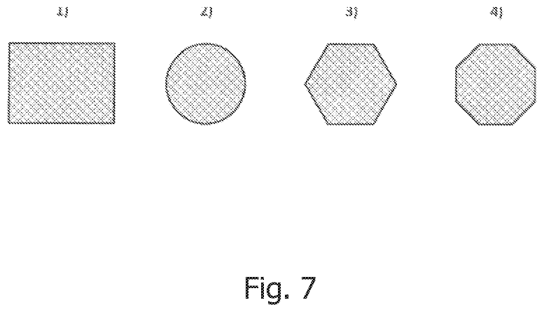

FIG. 7 exemplary cross-sectional shapes of an energy storage body,

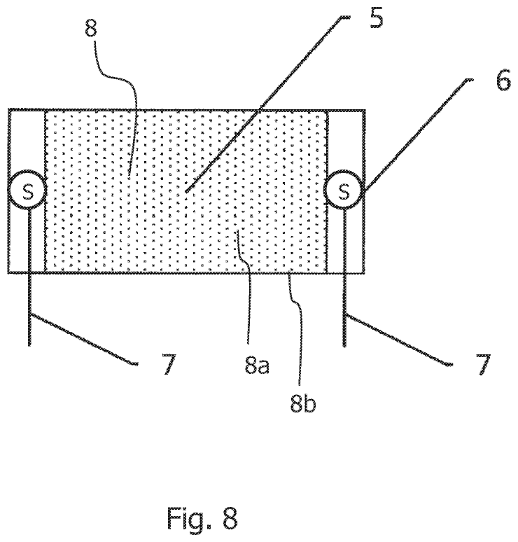

FIG. 8 an exemplary structure of an energy storage module,

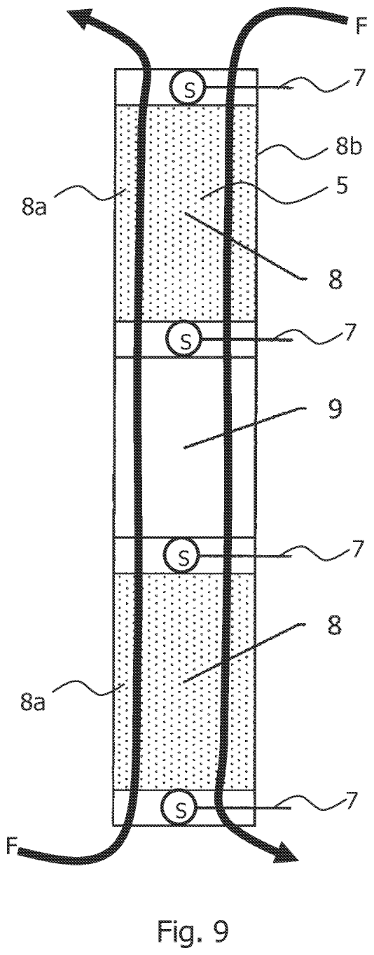

FIG. 9 an exemplary linear vertical structure composed of two energy storage modules having a process region located in between,

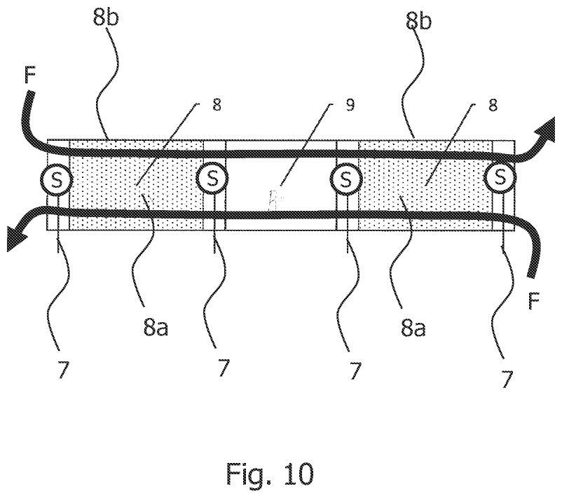

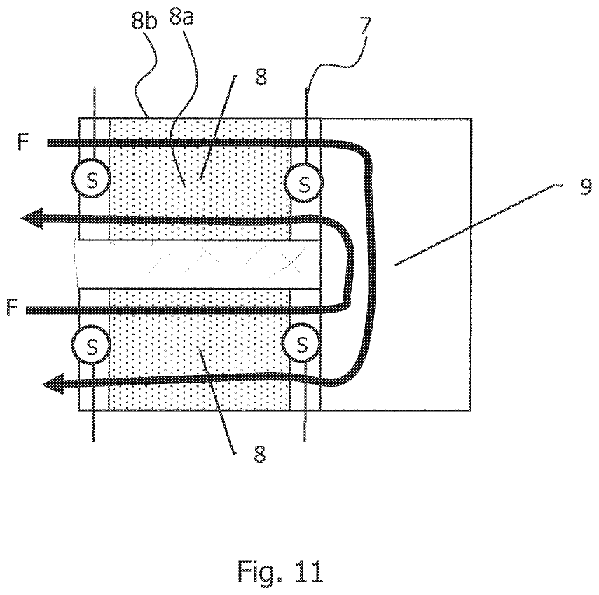

FIG. 10 an exemplary linear horizontal structure composed of two energy storage modules having a process region located in between,

FIG. 11 an exemplary structure across corners composed of two energy storage modules with a process region following thereto,

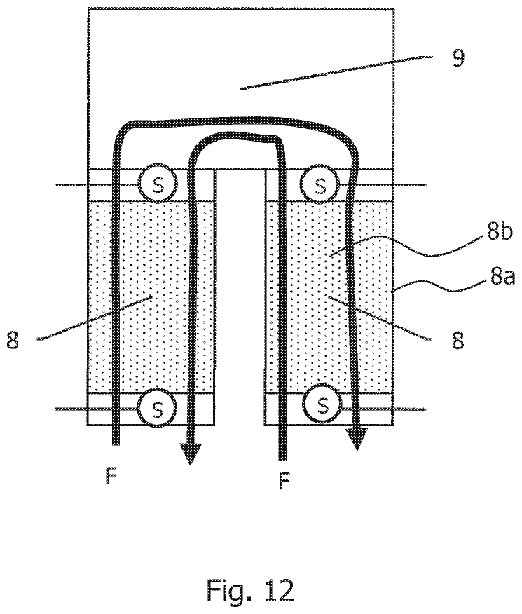

FIG. 12 a further exemplary structure across corners composed of two energy storage modules with a process region following thereto.

In all of the exemplary embodiments explained here, the following basic configuration applies:

In the following, the term “energy storage” means a space through which a fluid can flow and which is filled with a substance. The substance used for energy storage ideally is a material of low thermal conductivity (i.e. a heat insulator), with the material moreover having high specific heat capacity. The substance in the energy storage may be both a fluid, in particular a liquid, but also a solid matter in the form of granulate or powder, but also a porous solid body that can be flown through.

FIGS. 1 to 4 show the fundamental method steps of the cyclical energy storage according to the invention. For this purpose, an energy storage medium W is provided. The energy storage medium W may in particular be ceramics of low thermal conductivity and which can be flown through by a fluid. The energy storage medium is located between two areas of different temperatures. The area having the higher temperature constitutes the hot side H of the energy storage medium W, the area having the lower temperature constitutes the cold side K of the energy storage medium. The hot side H or the cold side K is in this case allocated to a process space which is to be temperature-controlled and from which energy is to be cyclically withdrawn, and into which energy is to be supplied again cyclically. If the process space is allocated to the hot side, the process is kept at a higher temperature, thus is finally heated, if the process space is allocated to the cold side, the process is kept at a lower temperature, thus is finally cooled.

The terms “hot side” and “cold side”, however, do not imply anything about the magnitude of the temperature difference between the areas referred to in this case, they only indicate on which side a higher and on which side a lower temperature is present. Likewise, the following terms “hot medium” and “cold medium” are only used for characterizing the circumstance that the respective fluids have different temperatures.

In the example of FIGS. 1 to 4, the hot side H is allocated to the process to be temperature-controlled. The energy storage medium W is provided with a thermal insulation I towards the outside. However, there is a thermal connection with respect to the hot side H and the cold side K, but it is likewise possible for fluids to flow through the energy storage medium.

On the cold side K of the energy storage medium, a sensor S is arranged. The sensor measures a measurement variable which is indicative of the energy content of the energy storage medium. This may be, for example, the humidity content of the energy storage medium. The sensor S may in particular be realized as a temperature sensor which measures the temperature of the energy storage medium in the area of the cold side and outputs it to an external control unit not shown here. During the energy storage cycle described below, the external control unit controls the fluid flow to and through the energy storage medium W. This is performed in particular by switching pumping devices not shown here, and by adjusting valve positions.

In the first method step shown in FIG. 1, warm fluid flows from the hot side H as a hot medium HM in the direction of the cold side through the energy storage medium. In this case, the fluid transfers a certain energy quantity Q little by little to the energy storage medium W and thereby heats it. This heating starts on the hot side H and proceeds little by little in the direction of the cold side K in the form of a heat front WF. Thereby, a temperature gradient between the hot side H and the cold side K is created within the energy storage medium. In this case, a high temperature T_{high} on the hot side, and a low temperature T_{low} on the cold side are present.

With progressing duration of time, the heat front WF advances through the entire energy storage medium W and finally penetrates up to the cold side K.

The arrival of the heat front WF is finally registered on the cold side K by the sensor S arranged there. The metrological criterion for the arrival of the heat front WF in the example present here is reaching a certain predefined limit temperature Tₗᵢₘᵢₜ on the cold side K of the energy storage medium. The temperature gradient prevailing now in the energy storage medium now occurs between the high temperature T_{high} on the hot side H and the limit temperature Tₗᵢₘᵢₜ on the cold side K.

As soon as the limit temperature Tₗᵢₘᵢₜ has been reached, the fluid flow from the hot side H to the cold side K is stopped by the external control unit before energy from the energy storage medium W can pass over directly to the environment of the cold side K. This is performed by adjusting corresponding valves and/or pumping devices.

According to FIG. 3, the flow of the fluid is reversed by the control unit and by changing over the external valves and/or pumping devices. This changing over takes a certain changeover time in which the fluid virtually is immobile, and which therefore represents a dead time t_{dead} for the process.

The fluid flows now as a cold medium KM from the cold side H through the energy storage medium W to the hot side H. As a consequence of this, the temperature of the energy storage medium registered by the sensor S, drops again below the limit temperature Tₗᵢₘᵢₜ. The heat front is now pushed back from the cold side K to the hot side H of the energy storage medium W. On this occasion, the energy Q stored within the energy storage medium W is returned back again to the hot side H.

For the period of this returning back and for the point of time of the changeover in turn taking place thereafter, the criterion fundamentally applies that the changeover is performed when the predefined temperature of the hot medium falls below a specified value.

In a combined system of two heat accumulators operating in the push-pull mode, this point of time is defined as the moment when the temperature increase occurs on the second heat accumulator on the cold side.

The energy storage medium thus operated as a cyclical energy buffer which takes up the energy from the hot side H, buffers it, and finally returns it back to the hot side.

The method steps mentioned can now be repeated, whereby the cycle is closed and begins anew. The duration of time from the start of the cycle to the completion of pushing back the energy Q to the hot side will be referred to in the following as cycle time t_{cycle}.

Because of the cyclical and thus principally periodic progress of the operation described here, other definitions of the cycle time may also be made. The cycle time may also be defined such that it refers to the duration of time starting from the temperature increase on the cold side on the one side up to the increase on the other side.

The cycle time t_{cycle} has a characteristic dependence on the number of cycles passed through, i.e. the cycle number n. In FIG. 5, this dependence is schematically illustrated. At the start of the cyclical operation of energy storage, the cycle time is first high and then drops with the increasing number of cycles. Finally, it adapts to a limit cycle time tₗᵢₘᵢₜ which substantially remains constant for all of the further cycles. The range of the first cycle numbers at which the cycle time decreases from a starting maximum value, constitutes the starting phase An of the cyclical method for energy storage. The range of the subsequent cycles in which the limit cycle time has been reached and, at otherwise consistent conditions, substantially only fluctuates around a constant value, constitutes the actual working phase Ar of the cyclical method for energy storage according to the invention.

FIG. 6 shows the temperature fluctuation in dependence on the number of cycles measured at the sensor of the energy storage medium, i.e. at the temperature sensor here, in the example present here. As described, the method is configured such that the limit temperature Tₗᵢₘᵢₜ is defined in advance in a control unit and is not exceeded during the method. The temperature present and measured at the sensor may therefore be only lower than or equal to the limit temperature Tₗᵢₘᵢₜ. Below the limit temperature Tₗᵢₘᵢₜ, the measured temperature oscillates in the course of the cycles passing through within a certain range of fluctuation which is referred to as Δ in the diagram present here. The range of fluctuation Δ is comparably large at the beginning of the cyclical energy storage, i.e. during the starting phase An, but decreases and approaches a constant, however different from zero, fluctuation limit value Δₗᵢₘᵢₜ with an increasing number of cycles. The adjustment of the range of fluctuation Δ to the reached constant fluctuation limit value Δₗᵢₘᵢₜ then marks the transition from the starting phase to the working phase of the cyclical energy storage method. The fluctuation limit value Δₗᵢₘᵢₜ then marks the amount of energy that can ultimately be stored and transferred back to the cyclical process, which can be taken up and re-transferred by the cyclical energy storage method.

As the method steps, a thermal loading, a subsequent change-over and a following thermal discharging are thus differentiated, as described. The term “thermal loading” here designates the introduction of energy into the energy storage medium, the term “thermal discharging” expresses that energy is extracted again from the energy storage medium.

The use of an energy accumulator having the worst possible thermal conduction is advantageous. Due to good thermal conduction in the energy accumulator, the total efficiency of energy recovery is strongly influenced in a negative manner. In a bad heat conductor, i.e. a thermal insulator, the heat front moves ahead only very slowly during energy storage. The heat front thereby has a steep increase. The movement of the heat front depends on the flow velocity. Thereby, the accumulator is filled slowly, but substantially little by little with the introduced energy due to the fluid flowing through it until a breakthrough occurs, i.e. the introduced energy is discharged into the external environment. Thereby, the temperature difference for the heat transfer is also kept large, so that the energy flow, when passing through the module quickly, is performed in a faster and simpler way.

It should be pointed out here that it is not important to simply cool or heat the fluid passing through the energy storage medium, i.e. to bring it as a whole to a high or low temperature as quickly as possible. Rather, it is important to subject the energy storage medium to energy in a manner that is as easy to control as possible, and to extract energy from there again.

In contrast to that, the energy is discharged already at an early stage in case of a material of good thermal conduction. This even happens already when the energy accumulator has been flown through by only a part of the cycle volume of the fluid. It is precisely this effect which should be expressly avoided in the method according to the invention.

Two important aspects are significant here. First of all, the dwell time or flow velocity of the fluid flowing through in the energy storage system needs to be coordinated such that the energy can pass over from the flowing fluid to the energy storage medium in such a way that the energy storage medium is saturated as far as possible. If the dwell time of the fluid is too short, the energy is not completely transferred to the energy storage medium. The second aspect relates to the complete utilization of the thermal capacity of the energy accumulator. If, for example, hollow ceramics is used, a certain wall thickness is thereby predefined which needs to be utilized as completely as possible in the thermal conduction from the outside to the inside for energy storage.

The time required for the thermal conduction likewise has to be taken into account. In a best possible coordination of the dwell time, ideally almost the entire storage volume of the energy storage medium adopts the maximum predefined process temperature, i.e. substantially the limit temperature Tₗᵢₘᵢₜ, before the stored energy is discharged again.

For fluidically switching the fluid flow by the energy storage modules filled with the energy storage medium, the exclusive use of highly dynamical valves or flaps is advantageous. This enables correspondingly short switching times and thus dead times to be minimized.

The system may also be employed such that the area of the process to be temperature-controlled is kept cool and is located between two energy storage media. In such a case, the hot or warm zones of the energy storage media are located on the outer side with respect to the process space. An application for this purpose, for example, is residential ventilation without the living area being affected by heating. This enables the energy of the otherwise additionally present air-conditioning technology to be saved. In such a configuration, in each case a temperature sensor at the end and the beginning of each energy accumulator is very purposeful.

The energy accumulator is thus operated as an active system having a sensor system for measuring parameters of the fluid flowing through the energy storage medium and the temperature of the energy storage medium. The sensor system prevents energy discharge or energy loss from an internal energy recovery system.

In the starting phase of the energy storage process, it is possible to perform only a partial energy loading of the accumulators so as to make the energy accumulator ready for operation more quickly. This allows the reaching of the limit cycle time tₗᵢₘᵢₜ to be accelerated.

Subsequently, some especially temporal method aspects will be explained in more detail. In the following explanations, V_{cycle} designates the cycle volume, V_{dead} the dead volume, M_{cycle} the cycle mass, M_{dead} the dead mass, and t_{cycle} the cycle time and t_{dead} the changeover time. In the subsequent consideration, it is assumed that the energy accumulator is in the working phase and the cycle time t_{cycle} corresponds to the limit cycle time tₗᵢₘᵢₜ. Thus, t_{cycle}=tₗᵢₘᵢₜ applies.

The changeover time t_{dead} subsequently designates the duration of time required for changing the flow directions of the fluid flowing through the energy storage medium. During this time, neither an energy transfer to the energy storage medium nor an energy recovery from the energy storage medium takes place. Actually, no fluid is moved through the energy accumulator during the changeover. The changeover time t_{dead} thereby designates a real dead time of the entire cyclical process.

The cycle volume V_{cycle} is in this case the volume of the fluid which can be actively driven through the energy storage medium during passing through a cycle, the dead volume V_{dead} designates the volume of the fluid necessarily idle and thus not moved during the changeover time in the energy storage medium and the corresponding feed lines. The cycle mass M_{cycle} is in this case the total amount of the fluid moved during the cycle, the dead mass M_{dead} is the fluid amount necessarily not moved, i.e. stationary, during the changeover time t_{dead}.

Basically, it applies advantageously that the changeover time t_{dead} should be small as compared to the cycle time t_{cycle}. On that condition, the cycle volume V_{cycle} is large as compared to the dead volume V_{dead}, and it applies:

V_{cycle}>>V_{dead}

Likewise, it applies then that the cycle mass M_{cycle} is large as compared to the dead mass M_{dead}.

V_{cycle}>>M_{dead}

The respective masses may be determined from the volumes, wherein the corresponding relationships in gaseous or liquid, i.e. compressible and incompressible media are considered on this occasion.

During the changeover time, substantially only the valves are adjusted or at most the conveying direction of pumps is changed. It applies advantageously, that the cycle time t_{cycle} should be large as compared to the changeover time t_{dead}:

t_{cycle}>>t_{dead}.

The changeover is thus performed in the shortest possible time. If the process region to be temperature-controlled is located between two energy storage modules and the process region is thus first flown through from the one direction and then from the opposite direction, an almost permanent flow of the fluid is generated by the very fast changeover between the at least two energy accumulators within one module, with an energy transfer of more then 90%, which can also be increased to a proportion of over 99%.

From a technical point of view, this method may be enhanced variably in its efficiency on the basis of the configuration by realizing the heat exchanger to be very long and by keeping the changeover times extremely short. This can only be implemented economically up to a certain application-specific point.

The total volume or the total mass of the available fluid thus is reduced in each case by the dead volumes V_{dead} or the dead masses M_{dead}, and namely in dependence on the partial times of the energy storage, i.e. the cycle time t_{cycle} and the dead or changeover time t_{dead}. These are calculated from the following relationships:

The required total time tₜₒₜₐₗ of the energy storage is the sum of the cycle time t_{cycle} and the changeover time t_{dead}:

tₜₒₜₐₗ=t_{cycle}+t_{dead} [s]

The volume transformed during the total time is calculated from the partial volumes transformed or present during the times t_{cycle} and t_{dead}:

Vₜₒₜₐₗ=V_{cycle}(t_{cycle})+V_{dead}(t_{dead}) [m³]. A corresponding relationship applies here also for the respective partial masses.

The share of the cycle time in the total time At_{cycle} is calculated from the relationship between the cycle time and the total time:

At_{cycle}=t_{cycle}/tₜₒₜₐₗ,

the share of the changeover time in the total time At_{dead} results from:

At_{dead}=t_{dead}/tₜₒₜₐₗ.

The number of cycles per hour is defined by a factor F, with the factor F=3600 s/tₜₒₜₐₗ. This allows the total volume flow Vₜₒₜₐₗₕ per hour to be calculated as follows:

Vₜₒₜₐₗₕ=Vₜₒₜₐₗ*F [m³/h].

This total volume flow Vₜₒₜₐₗₕ per hour results from the sum of the changeover volume Vₛ and the useful volume Vᵤₛₑ:

Vₜₒₜₐₗₕ=Vᵤₛₑ+Vₛ [m³/h].

The factor F allows the changeover volume Vₛ and the useful volume Vᵤₛₑ per hour to be calculated in this case. In this case, the changeover volume Vₛ is determined from the dead volume V_{dead} while using the factor F to be Vₛ=V_{dead}*F [m³/h].

The useful volume per hour Vᵤₛₑ is the sum of the cycle volume flow V_{cycle} per hour [m³/h] and is determined by means of the factor F to be

Vᵤₛₑ=V_{cycle}*F [m³/h].

Here as well, the masses can be calculated correspondingly.

To ensure that the energy storage system is as compact as possible, the energy accumulator may be of a modular structure.

FIG. 7 shows exemplary cross-sectional shapes of an energy storage module. As the examples shown here demonstrate, the cross-sectional shape is not limited to a certain shape. It can be rectangular, in particular square, circular to oval, or polygonal, in particular hexagonal or even octagonal. The appropriate selection of the specific cross-section results in the individual case from a consideration of the production effort, on the one hand, and from an appropriate selection of the relationship between volume and surface, on the other, so as to provide a large energy storage volume, on the one hand, and to minimize the surface and thus the energy losses to the environment on the other hand.

FIG. 8 shows the basic structure of an exemplary energy storage module 8. The individual energy storage module is composed of a filling 5 of energy storage material. This filling constitutes the energy storage body 8a. The energy storage body is surrounded by a thermal insulation 8b towards the outside. The energy storage material serves as an energy storage mass. Appropriately, this energy storage material can be flown through by a fluid and may be realized, for example, as a loose ceramic bulk or a porous ceramic body. The energy storage material is surrounded by a module housing 6. The inflow or outflow of the fluid takes place within the module housing. Via temperature sensors 7, the temperature of the fluid at the inlet and outlet of the energy storage module and the temperature of the energy storage module within the filling 5 are continuously monitored.

FIG. 9 shows a coupling of energy storage modules 8 in a vertical configuration. In this configuration, as well, a filling 5, a module housing 6, and a temperature sensor 7 are in each case provided. Each of the energy storage modules includes an energy storage body 8a, which is in particular realized by the filling with the energy storage material, and an external thermal insulation 8b, which is in particular a part of the module housing. Between the coupled energy storage modules, the process region 9 is located which represents a flow direction reversal area into which and out of which the fluid F may be introduced in and discharged out from the energy storage modules. This flow direction reversal area includes the process to be temperature-controlled and thus marks the process region 9 to be temperature-controlled.

For the temperature control of the process region 9, the two energy storage modules work in the push-pull mode in the flow reversal area. The process region 9 constitutes in this case a flow reversal area which can be flown through from two sides in opposite directions depending on the work cycle. In principle, this happens such that from a hot energy storage module, i.e. loaded with energy, fluid is transferred through the flow reversal area 9 into the cold energy storage module, wherein an internal energy transfer between the two coupled modules thus takes place, and a discharge of the stored energy into the environment from the hot energy storage module is omitted. The rearrangement of the fluid between the energy storage modules, so to speak, generates a predefined direction, in which stored energy preferably can flow off in a predefined manner.

The coupling between the energy storage modules and the flow reversal area can be designed to be very variable in geometry and in their positions. In FIG. 10, the coupling is realized in a horizontal configuration, for example.

Both in the example of FIG. 9 and the example of FIG. 10, the energy storage modules 8 are arranged linearly in a row. This configuration as well represents only one possible exemplary embodiment. The examples of FIGS. 11 and 12 show angles arrangements between the energy storage modules, in which the fluid is guided around at least one angle between the two energy storage modules. The two energy storage modules are otherwise separated from one another so that a direct fluid or energy transfer cannot take place between the individual modules.

A device for the temperature-control of a process region is thus appropriately based on an arrangement of at least two energy accumulators, in particular of at least two energy storage modules which are alternatingly loaded and unloaded with energy from the fluid flowing past the process to be temperature-controlled and through the module. The energy to be stored and the available total energy capacity hereby are divided into small portions and often are switched back and forth via the fluid flowing through. The more often the accumulators are loaded and unloaded, the smaller the capacity of the individual energy storage module must be designed. Due to this procedure, the energy slip is reduced to a minimum.

The configuration with the at least two energy storage modules may have different shapes. According to the representations in FIGS. 9 and 10, several energy storage modules may be adjacent to the flow reversal area 9 in particular in a linear manner or according to the representations in FIGS. 11 and 12 at one or several angles or via curvatures.

In the structure of FIG. 9, the flow reversal area 9 is arranged between two energy storage modules 8. This entire linear arrangement is flown through by a continuous fluid flow F in alternating directions. In the cycle of the entire process, the flow direction changes in this case within the entire system and in particular in the flow reversal area 9 which contains the process to be temperature-controlled. Several temperature sensors 7 are in this case provided on the energy storage modules 8 and register the temperatures present in the energy storage modules.

This linear arrangement according to FIG. 9 can be configured both vertically and horizontally. The flow reversal area including the process to be temperature-controlled is in this case enclosed by the energy storage modules either laterally or between the upper and lower sides of the flow reversal area.

As far as the execution is concerned, the linear structure with the process region between the at least two energy accumulators is advantageous due to the simple manufacture, and a vertical structure with the two or more energy accumulators in parallel next to each other, and the process region at the transition between the at least two energy accumulators at the upper end for an improved energy return by using convection are advantageous. Combinations and modifications thereof are likewise possible.

In the embodiment from FIG. 11 and the embodiment from FIG. 12, the flowing fluid F is conducted in alternating directions across corners. The energy storage modules 8 are adjacent to the flow reversal area 9 at a common side area.

As the fluid F, gases, in particular He, N, H₂, CO₂, CO, O₂ other gases or mixtures, e.g., natural gas or air, plasma, or vapor are conceivable. Liquids, ionic liquids or even melts can likewise be used. Solid substances that are similar to fluids, may likewise be used in particular in the form of a bulk product such as, for example, sands or combinations of gases, liquids, plasmas or solid substances that are similar to fluids. The latter may be sands, powders or granulates which are in particular flowable.

The cycle time t_{cycle} of the configuration present here normally is in the minute range, for example, a maximum of 10 minutes and a minimum of 20 seconds. The changeover time t_{dead} normally is in the second range, for example, a maximum of 3 seconds and a minimum of 1 millisecond.

The ratio between the cycle time t_{cycle} and the changeover time t_{dead}, i.e. the quotient t_{cycle}/t_{dead} must be made as large as possible, in order to keep the dead volume low and to generate an almost continuous flow. Appropriately, the ratio should be at least 100. A ratio of 500 or larger than 1,000 is advantageous. The larger the factor, the higher the theoretically possible energy recovery.

The ratio between the cycle volume V_{cycle} (ex. 300 m³/h) and the dead volume V_{dead} (ex. 0.45 m³/h) of the fluid, i.e. the quotient t_{cycle}/t_{dead} should not fall below a value of 100 within the given cycle time. A ratio between the cycle volume and the dead volume in the range of 200 or even more than 300 is advantageous.

The cold fluid is appropriately fed via a temperature-controlled system. This ensures a controlled temperature in the accumulators and an overheating protection. The temperature control is possible at any place in front of the accumulators.

Within the scope of the method, it is in principle always possible to remove warm fluid also from the energy storage process. The warm fluid can hereby be used for utilizing the energy in other processes, and its removal enables an overheating protection both of the energy accumulator and the temperature-controlled process. Such a removal of the warm fluid is practically possible at any point in time before and after storing, as well as from the process region of the energy.

The process of feeding and removing the fluid may proceed in parallel.

A parallel connection of several modules via the system may be implemented for increasing the throughput, the volume flow, or for reducing the stress or the pressure loss.

It is possible to introduce a further matter as a storage increase or functional unit into the process space. A series connection of several modules for combining several analysis systems having different temperatures, several material separation or transformation processes taking place one after the other at other input parameters, several both different and identical repeating reaction steps, for example, for increasing the yields may be made.

The method for energy storage and the exemplary configurations here as far as the device is concerned have the advantage that the temperature at the outlet of the energy storage system is only slightly above the inlet temperature. Thereby, alternative sensors are less thermally stressed, and sensors can be used that hitherto could not be employed. A control of the process temperature according to the reaction products can thereby be performed, for example.

The method for energy storage and the exemplary configurations here as far as the device is concerned have the advantage that the method sequence can be stopped virtually without any slow overshooting. This enables a relatively rapid restart of the system if the downtime is not extended too much and enough stored energy remains in the system. Simple adaptations of the system in an easy manner are also possible subsequently, namely by adapting the energy storage material, the sensor system, the control parameters, by adapting the energy storage geometry, the energy storage mass and the energy storage surface.

The energy accumulator appropriately is configured to be decomposable and thus simple to repair. Here, a modular design is advantageous, in which the filling may in particular be removed from the module housing as a constructional component and be exchanged. The entire arrangement can thereby be partially or completely be replaced, repaired and maintained in a simple manner. A storage of the energy is possible both positively in the form of heat, and negatively in the form of cold according to the heating or cooling processes.

The energy recovery is possible even at very small temperature differences of less than 10 K, in particular less than 5 K, and even in case of a temperature difference of less than 1 K.

The heat exchanger within the energy recovery system can be operated at a variable volume flow between zero and a maximum value. At a volume flow of almost zero, the heat transfer is almost complete. The cycle time adopts very large values, whereas the portion of the changeover time becomes very small in comparison.

The maximum value for the volume flow, in contrast, is dependent on the flow velocity, the inner surface of the energy accumulator, the temperature difference, and further variables. Above the maximum value, heat may longer be transferred to the energy accumulator completely and substantially only flows past the energy accumulator with the fluid. In this case, the portion of the changeover time would be too large and the efficiency would drop. The maximum value for the volume flow thus is a system-specific variable.

A very compact design of the individual energy storage modules is possible, since the insulation can be omitted or at least be strongly reduced due to the short changeover times and the therewith associated strong reduction of the energy conduction between the energy accumulators.

Due to the very high energy recovery, electrical current may now also be employed as heating medium apart from natural gas. This is also possible for large fluid flows. Ideally, current from regenerative sources is applied for this purpose for sustainably reducing CO₂. For enhancing sustainability, the use of hydrogen as heating medium would also be possible.

The method for energy storage and return may be used in different systems and in different fields of application:

A first field of application is analysis systems: this concerns in particular method sequences and processes, in which a sensor around and through which a fluid flows, needs to be kept at a temperature or in a determined temperature range.

A further field of application concerns thermal systems, in particular thermal methods for energy transfer (heating, cooling), for substance separation and/or substance transformation, e.g., extraction, rectification, adsorption, desorption, drying, catalysis, in which certain temperature ranges need to be observed, and arising energy quantities need to be returned back into a certain system or system portions.

Furthermore, the energy storage method according to the invention can be applied to reaction systems, thus in particular in oxidation, reduction, synthesis methods, in which a medium must be heated to a certain temperature.

The energy storage method according to the invention may also be applied in fluid exchange systems, in particular in association with a sensor system for monitoring, controlling and setting of values or ranges for compositions of fluids, such as, e.g., hydrogen, nitrogen, carbon monoxide, carbon dioxide, oxygen, in which the relative air humidity, the temperature, organic pollutants, or other gases, liquids and particles or fluids, and mixtures thereof, need to be controlled according to definition.

Furnaces with gas burners represent a further field of application, in which a supply of preheated oxygen is intended to be performed. Here, the system according to the invention allows an increase of the furnace temperature and thus of the efficiency of the furnace to be achieved.

A further field of application is condensing liquids below the dew point or by using adsorbents.

In one embodiment, the method may be linked to a process such that the airflow creates a recirculating air system which is temperature-controlled by the method, for example, for a sinter furnace.

The applications may also be used in combined methods, in which several of the fields of application mentioned above are coupled.

Finally, the achieved advantageous effects of the energy accumulator according to the invention will be briefly summarized again:

The energy recovery degree may be as high as 99.99%. It is independent of the temperature difference. The energy recovery degree is controllable. The pressure loss sloping via the energy storage modules can be designed variably and, as compared to standard heat exchangers, is substantially lower. The volume flow of the fluid is freely selectable, wherein this is dependent on the ventilator performance or the power of the pump each circulating the flowing fluid. The operation of the energy accumulator is performed via an active control. Due to a modular structure, the entire arrangement is flexible. A weight saving of 50% is achievable as compared to countercurrent plate heat exchangers.

The energy accumulator according to the invention has a compact and variable shape. The pressure loss is individually adaptable. The utilization of excess energy is directly possible. The use of ceramics as energy storing material causes a temperature stability of up to 1,200° C. There is high chemical resistance, in particular when ceramic materials are used for energy storage. Ceramics have a lower heat expansion coefficient as compared to metals, e.g., steel, stainless steel, so that it is of long-term stability as compared to standard heat exchangers.

Due to the achievable compactness of the systems, the absolute thermal expansion is also minimized at a constant volume flow.

The achievable useful life may be more than 10 years. The modular design of the energy accumulator causes a simple decomposable structure with inexpensive spare parts and high availability.

The method according to the invention and the device according to the invention have been explained on the basis of examples. Within the scope of expertise action further configurations are possible. Further embodiments moreover result from the dependent claims.

### LIST OF REFERENCE NUMERALS

An starting phase
Ar working phase
F fluid
H hot side
HM hot medium
I thermal Insulation
K cold side
KM cold medium
Q energy quantity
T temperature sensor
S sensor
W energy storage medium
WF heat front
1 square
2 circular
3 hexagonal
4 octagonal
5 filling with energy storage material
6 module housing
7 temperature sensor
8 energy storage module
8a energy storage body
8b thermal insulation
9 flow reversal area

1. A method for performing cyclical energy storage for a process space (P) in a cyclical operation using a storage medium (W) having a hot side (H) and a cold side (K) by the following method steps repeated within a cycle time (t_{cycle}), with the following energy storage cycle:
heating the energy storage medium (W) on the hot side (H) by means of a hot medium (HM) in order to initiate an energy transfer to the energy storage medium (W) from the hot side (H) to the cold side (K),
continuously registering the sensor values on the cold side (K) of the energy storage medium (W) by means of a sensor (S) and comparing them to a preset limit value (Sₗᵢₘᵢₜ) (FIGS. 2 and 6),
after reaching the limit value (Sₗᵢₘᵢₜ), feeding a cold medium (KM) to the cold side (K) of the energy storage medium (W) and discharging the stored energy starting from the cold side (K) towards the hot side (H) of the energy storage medium (W),
heating the energy storage medium (W) on the hot side (H) again, and starting a new energy storage cycle.

2. The method according to claim 1,
characterized in that
the cyclical operation has a starting phase (An) and a working phase (Ar), wherein several energy storage cycles are passed through in the starting phase until the cycle time (t_{cycle}) for each energy storage cycle has reached a constant limit cycle time (tₗᵢₘᵢₜ), and wherein in the working phase, the energy storage cycles each are performed within the limit cycle time (tₗᵢₘᵢₜ)

3. The method according to claim 1,
characterized in that
the energy storage medium (W) is formed as a material of bad thermal conduction, wherein the material of bad thermal conduction is flown through from the hot side (H) towards the cold side (K) by the hot medium and from the cold side (K) to the hot side (H) by the cold medium (KM).

4. The method according to claim 1,
characterized in that
the energy storage medium (W) is allocated to two energy storage modules that are fluidically separated from one another, wherein both energy storage modules join a process space to be temperature-controlled, and the energy storage modules and the process space are flown through by a continuous volume flow, wherein both energy storage modules are operated in a cyclical push-pull mode.

5. The method according to claim 1,
characterized in that the modules, depending on the requirements, can be connected in parallel or in series in an arbitrary manner.

6. The method according to claim 1,
characterized in that
the cycle time (t_{cycle}) is selected such that almost no thermal conduction takes place within the energy storage medium (W).

7. The method according to claim 1,
characterized in that
the internal free volume and the volume of the energy storage medium (W) are kept as small as possible depending on the cycle time (t_{cycle}).

8. The method according to claim 1,
characterized in that
the changeover time (t_{dead}) is selected to be much shorter as compared to the cycle time (t_{cycle}).

9. The method according to claim 1,
characterized in that
an introduction of an additional medium is performed in the process space.

10. The method according to claim 1,
characterized in that
a discharge of a medium is performed in the process space.

11. The method according to claim 9,
characterized in that
the introduction and discharge of the medium are performed temporally in parallel.

12. The method according to claim 1,
characterized in that
the process space is in part to completely filled by one medium or more media that can flow through.

13. The method according to claim 1,
characterized in that
the energy can also be stored in the form of cold.

14. A device for performing cyclical energy storage on a process space (P) having an energy storage module (8) with the following components:
an energy storage body (8a) of a material of low thermal conductivity that can be flown through by a fluidic medium,
an external thermal insulation (8b) at least partially surrounding the energy storage body (8a), at least one respective connection for introducing and/or discharging a fluid (F), and at least one sensor (S) arranged on the energy storage body (8a), for example a temperature sensor for measuring the temperature of the fluid.

15. The device according to claim 14,
characterized in that
the energy storage body (8a) is made of ceramics, a composite material or a liquid having low thermal conductivity.

16. The device according to claim 14,
characterized in that
the energy storage body (8a) is made of one or more molded bodies, e.g., monoliths, granulate or powder.

17. The device according to claim 14,
characterized by
an arrangement of two energy storage modules (8) following the process space and fluidically directly separated from one another.

18. The device according to claim 14,
characterized in that
the energy storage modules (8) are linearly connected on both sides to the process region (9).

19. The device according to claim 14,
characterized in that
the energy storage modules are connected to the process region in a U-shape.

20. The device according to claim 14,
characterized in that
the energy storage bodies (8a) have a prismatic shape with an arbitrarily selectable base area.
